(19) United States
(12) Patent Application Publication
(10) Pub. No.: US 2026/0247298 A1
(43) Pub. Date: Aug. 20, 2026

(54) DYNAMIC BROADCAST POWER CONTROL

(71) Applicant: QUALCOMM Incorporated, San Diego, CA (US)

(72) Inventors: Joel LINSKY, San Diego, CA (US); Jie ZENG, Shanghai (CN); Peng CHEN, Shanghai (CN); Brian REDDING, Urbana, IL (US); Mayank BATRA, Cambridge (GB)

(21) Appl. No.: 19/471,212

(22) PCT Filed: May 18, 2023
(86) PCT No.: PCT/CN2023/094964

§ 371 Date: Sep. 30, 2025

(51) Int. Cl. H04W 52/24; H04W 52/32; H04W 52/36

(52) U.S. Cl. CPC H04W 52/24; H04W 52/322; H04W 52/367

(57) ABSTRACT

Various aspects of the present disclosure generally relate to wireless communication. In some aspects, a source device may receive information associated with identifying a link characteristic for a first communication link between the source device and a primary sink device or for a second communication link between the source device and a set of secondary sink devices. The source device may transmit, using a transmit configuration associated with the link characteristic, a broadcast signal to the primary sink device and the set of secondary sink devices. Numerous other aspects are described.

### FIELD OF THE DISCLOSURE

Aspects of the present disclosure generally relate to wireless communication and to techniques and apparatuses for dynamic broadcast power control.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP). Multi-access technologies may also include New Radio (NR) 5G or 6G.

A wireless network may include a number of base stations (BSs) that can support communication for a number of user equipments (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B (NB), a gNB, an access point (AP), a radio head, a transmit receive point (TRP), a New Radio (NR) BS, or a 5G Node B.

The UE may operate with peripheral devices (PDs) (e.g., earbuds, smart watches) using short-range wireless communication. Short-range wireless communication enables wireless communication over relatively short distances (e.g., within 30 meters). Bluetooth™ protocols are an example of a wireless technology standard for exchanging data over short distances using short-wavelength ultra high frequency (UHF) radio waves from 2.4 gigahertz (GHz) to 2.485 GHz. Bluetooth Low Energy (BLE) protocol is for communication with devices running on low power. Various other short-range wireless communication technologies may operate in a similar wavelength, such as wireless local area network (WLAN) technologies.

More particularly, wireless devices operating in the “Bluetooth” wireless communication spectrum (using the BLE protocol or a similar protocol, such as a “classic” or “legacy” Bluetooth protocol, or the like) are proliferating. In particular, the term “Bluetooth” generally refers to and defines a relatively short range wireless communication protocol, with an operating range ranging from a few meters to a few tens of meters. The Bluetooth specification includes various profiles that define the behavior associated with each communication endpoint to implement a specific use case. Several such use cases are contemplated in the Bluetooth specification, which are generally defined according to a protocol stack that promotes and allows interoperability between endpoint devices from different manufacturers through enabling applications to discover and use services that other nearby Bluetooth devices may be offering.

As the demand for short-range wireless communication technologies continues to increase, further improvements in Bluetooth and various other short-range wireless communication technologies remain useful.

### SUMMARY

Some aspects described herein relate to a method of wireless communication performed by a source device. The method may include receiving information associated with identifying a link characteristic for a first communication link between the source device and a primary sink device or for a second communication link between the source device and a set of secondary sink devices. The method may include transmitting, using a transmit configuration associated with the link characteristic, a broadcast signal to the primary sink device and the set of secondary sink devices.

Some aspects described herein relate to a method of wireless communication performed by a primary sink device. The method may include transmitting information associated with indicating a link characteristic for a first communication link between the source device and the primary sink device or for a second communication link between the source device and a set of secondary sink devices. The method may include receiving, using a transmit configuration associated with the link characteristic, a broadcast signal that is broadcast to the primary sink device and the set of secondary sink devices.

Some aspects described herein relate to a source device for wireless communication. The source device may include one or more memories and one or more processors coupled to the one or more memories. The one or more processors, individually, or in any combination, may be configured to receive information associated with identifying a link characteristic for a first communication link between the source device and a primary sink device or for a second communication link between the source device and a set of secondary sink devices. The one or more processors, individually, or in any combination, may be configured to transmit, using a transmit configuration associated with the link characteristic, a broadcast signal to the primary sink device and the set of secondary sink devices.

Some aspects described herein relate to a primary sink device for wireless communication. The primary sink device may include one or more memories and one or more processors coupled to the one or more memories. The one or more processors may be configured to transmit information associated with indicating a link characteristic for a first communication link between the source device and the primary sink device or for a second communication link between the source device and a set of secondary sink devices. The one or more processors may be configured to receive, using a transmit configuration associated with the link characteristic, a broadcast signal that is broadcast to the primary sink device and the set of secondary sink devices.

Some aspects described herein relate to a non-transitory computer-readable medium that stores a set of instructions for wireless communication by a source device. The set of instructions, when executed by one or more processors of the source device, may cause the source device to receive information associated with identifying a link characteristic for a first communication link between the source device and a primary sink device or for a second communication link between the source device and a set of secondary sink devices. The set of instructions, when executed by one or more processors of the source device, may cause the source device to transmit, using a transmit configuration associated with the link characteristic, a broadcast signal to the primary sink device and the set of secondary sink devices.

Some aspects described herein relate to a non-transitory computer-readable medium that stores a set of instructions for wireless communication by a primary sink device. The set of instructions, when executed by one or more processors of the primary sink device, may cause the primary sink device to transmit information associated with indicating a link characteristic for a first communication link between the source device and the primary sink device or for a second communication link between the source device and a set of secondary sink devices. The set of instructions, when executed by one or more processors of the primary sink device, may cause the primary sink device to receive, using a transmit configuration associated with the link characteristic, a broadcast signal that is broadcast to the primary sink device and the set of secondary sink devices.

Some aspects described herein relate to an apparatus for wireless communication. The apparatus may include means for receiving information associated with identifying a link characteristic for a first communication link between the apparatus and a primary sink device or for a second communication link between the source device and a set of secondary sink devices. The apparatus may include means for transmitting, using a transmit configuration associated with the link characteristic, a broadcast signal to the primary sink device and the set of secondary sink devices.

Some aspects described herein relate to an apparatus for wireless communication. The apparatus may include means for transmitting information associated with indicating a link characteristic for a first communication link between the source device and the apparatus or for a second communication link between the source device and a set of secondary sink devices. The apparatus may include means for receiving, using a transmit configuration associated with the link characteristic, a broadcast signal that is broadcast to the apparatus and the set of secondary sink devices.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a Bluetooth communication technology, in accordance with the present disclosure.

FIG. 2 is a diagram illustrating an example of an implementation using a Bluetooth protocol stack to support one or more logical connections, in accordance with the present disclosure.

FIGS. 3A-3C are diagrams of an example associated with dynamic broadcast power control, in accordance with the present disclosure.

FIG. 4 is a diagram illustrating an example process performed, for example, by a source device, in accordance with the present disclosure.

FIG. 5 is a diagram illustrating an example process performed, for example, by a primary sink device, in accordance with the present disclosure.

FIG. 6 is a diagram of an example apparatus for wireless communication, in accordance with the present disclosure.

FIG. 7 is a diagram of an example apparatus for wireless communication, in accordance with the present disclosure.

FIG. 8 is a diagram illustrating an example of a wireless communication device, according to aspects of the disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In unicast isochronous channels, such as Bluetooth audio channels, a source device (e.g., a user equipment (UE)) and a sink device (e.g., a set of earbuds or a speaker) may communicate on a control interface to enable transmit control. However, broadcast isochronous channels, in which a source device transmits a broadcast signal to a plurality of sink devices, may lack a control interface, which may prevent a source device from performing a power control procedure. In this case, the source device may use a static value for a broadcast power level set by a manufacturer of the source device.

The transmit power level affects a range at which the source device can successfully transmit to a set of sink devices and/or a power consumption (e.g., by the source device to transmit a signal and/or by a sink device to receive and process the signal). Other power parameters may also be statically configured, such as a modulation and coding scheme or a quantity of repetitions of data that are provided to enable redundancy for lost packets. When the set of sink devices are relatively close to the source device, a static transmit configuration (e.g., a static transmit power) may result in excessive power consumption. Alternatively, when the set of sink devices are relatively far from the source device, the static transmit configuration may result in insufficient range for a successful transmission.

Some aspects described herein enable dynamic broadcast power control. For example, a source device may receive information identifying a link characteristic for a broadcast link with a set of secondary sink devices or a unicast link with a primary sink device. As one example, the source device may receive information identifying a link margin, such as a received signal strength indicator (RSSI), a signal-to-noise ratio (SNR), a packet error rate, or a block error rate (BLER), among other examples. As another example, the source device may receive information identifying a range (e.g., of the primary sink device or the set of secondary sink devices). Based at least in part on receiving information identifying the link characteristic, the source device may select a transmit configuration for transmitting a broadcast signal. For example, the source device may select a transmit power level, a modulation and coding scheme, a redundancy version, or another parameter. Additionally, or alternatively, when the link characteristic changes, the source device may dynamically update the transmit configuration.

Additionally, or alternatively, the source device may receive information from the primary sink device explicitly setting the transmit configuration, such as a user selection of a transmit range for the broadcast signal.

Based at least in part on allowing for dynamic setting of a transmit configuration, the source device and/or one or more sink devices (e.g., a UE and/or one or more a sets of earbuds, respectively) may conserve power resources and/or processing, network, and/or communication resources that may have otherwise been consumed transmitting a signal with excess power or processing a signal with insufficient power. For example, based at least in part on setting a transmit power to a high level when a sink device is far away or interference is high, the source device may transmit to the sink device with reduced error rate, which may conserve computing resources to detect and/or correct for communication errors as well as resulting in poor playback fidelity. Similarly, based at least in part on setting a transmit power to a low level when a sink device is close or interference is low, the source device may transmit to the sink device with reduced power, which may conserver power resources and extend battery life without negatively impacting playback fidelity.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with short-range wireless communication protocols, aspects of the present disclosure can be applied to other protocols or radio access technologies (RATs), such as a 3G RAT, a 4G RAT, a 5G or New Radio (NR) RAT, and/or a RAT subsequent to 5G (e.g., 6G).

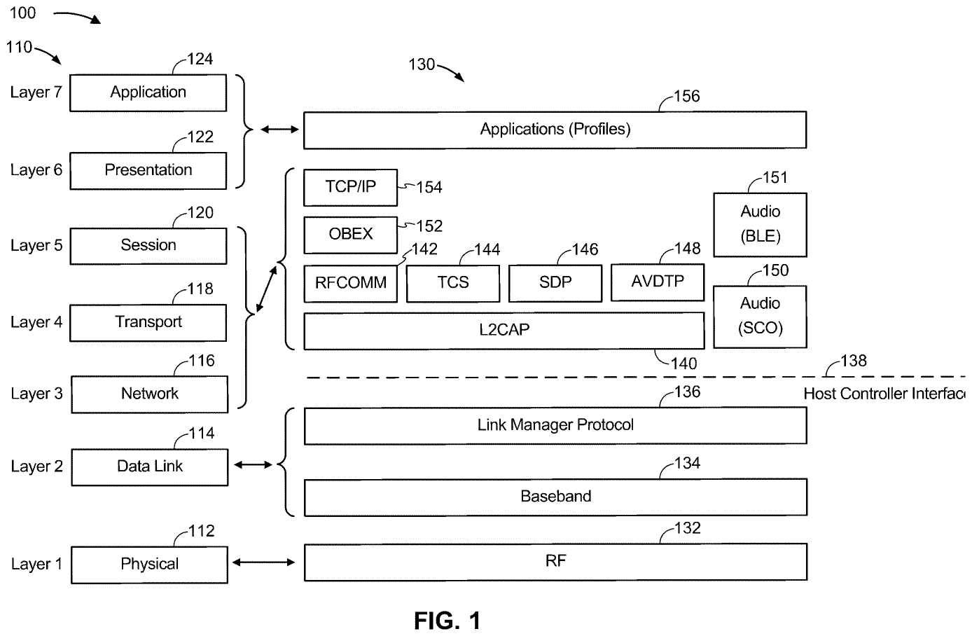

FIG. 1 is a diagram illustrating an example 100 of a Bluetooth communication technology, in accordance with the present disclosure.

More particularly, FIG. 1 illustrates a relationship between the Bluetooth protocol stack 130 and the seven layers in the Open Systems Interconnect (OSI) model 110, which was established to standardize information transmission between points over the Internet or other wired and/or wireless networks. In particular, the OSI model 110 generally separates communications processes between two points in a network into seven stacked layers, with each layer adding certain functions. Each device handles a message such that a downward flow through each layer occurs at a sending endpoint and an upward flow through the layers occurs at a receiving endpoint. The programming and/or hardware that provides the seven layers in the OSI model 110 is typically a combination of device operating systems, application software, transmission control protocol (TCP)/Internet protocol (IP) and/or other transport and network protocols, and other software and hardware.

More particularly, referring to FIG. 1, the OSI model 110 includes a physical layer 112 (OSI Layer 1) used to convey a bit stream through a network at a physical level. The Institute of Electrical and Electronics Engineers (IEEE) sub-divides the physical layer 112 into the PLCP (Physical Layer Convergence Procedure) sub-layer and the PMD (Physical Medium Dependent) sub-layer. The data link layer 114 (OSI Layer 2) provides physical level synchronization, performs bit-stuffing, and furnishes transmission protocol knowledge and management, or the like. The IEEE sub-divides the data link layer 114 into two further sub-layers, which comprise the Media Access Control (MAC) sub-layer to control data transfer to and from the physical layer and the Logical Link Control (LLC) sub-layer to interface with the network layer 116 (OSI Layer 3), interpret commands, and perform error recovery.

The network layer 116 (OSI Layer 3) handles data transfer across a network (e.g., routing and forwarding) in a manner independent from any media and specific network topology, the transport layer 118 (OSI Layer 4) manages end-to-end control and error-checking to multiplex data transfer across the network according to application-level reliability requirements, and the session layer 120 (OSI Layer 5) establishes, coordinates, and terminates conversations, exchanges, and dialogs between the applications to provide management and data flow control services.

The presentation layer 122 (OSI Layer 6) converts incoming and outgoing data from one presentation format to another, which may comprise adding service structure to the data units to provide data to the application layer 124 (OSI Layer 7) according to a common representation, while the application layer 124 is where communication partners are identified, quality of service (QOS) is identified, user authentication and privacy are considered, constraints on data syntax are identified, and any other functions relevant to managing communications between host applications are managed.

Turning now to the Bluetooth protocol stack 130, the radio frequency (RF) layer 132 generally corresponds to the physical layer 112 in the OSI model 110, the baseband layer 134 and the link manager protocol layer 136 generally correspond to the data link layer 114, and a Host Controller Interface (HCI) 138 separates the RF layer 132, the baseband layer 134, and the link manager protocol layer 136 from the upper layers. For example, the Physical Layer 112 in the OSI model 110 manages electrical interfaces to communications media, which includes modulation and channel coding, and therefore covers the Bluetooth radio in the RF layer 132 (and possibly part of the baseband layer 134), while the data link layer 114 manages transmission, framing, and error control over a particular link, which overlaps tasks performed in the link manager protocol layer 136 and the control end of the baseband layer 134 (e.g., error checking and correction).

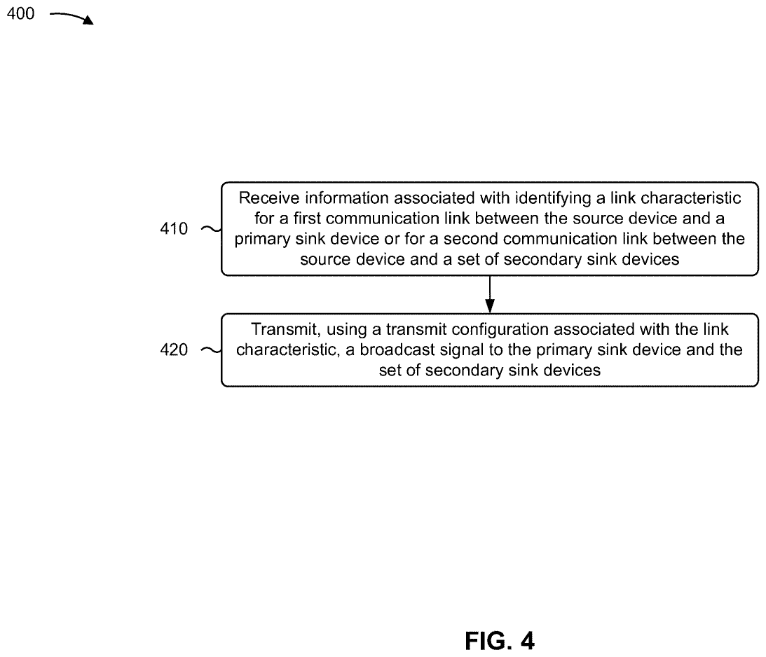

Above the HCI 138, the Logical Link Control and Adaptation Protocol (L2CAP) 140, RF communication (RFCOMM) channel 142, Telephony Control Specification (TCS) 144, Service Discovery Protocol (SDP) 146, Audio/Video Distribution Transport Protocol (AVDTP) 148, Synchronous Connection Oriented (SCO) Audio 150, Bluetooth Low Energy (BLE) Audio 151 (e.g., a Generic Audio Framework), object exchange (OBEX) 152, and TCP/IP 154 functions correspond to the network layer 116, transport layer 118, and session layer 120. The applications layer 156 comprises the Bluetooth profiles (e.g., the Handsfree Profile (HFP) for voice, the Advanced Audio Distribution Profile (A2DP) for high-quality audio streaming, the Video Distribution Profile (VDP) for video streaming, etc.) and corresponds to the presentation layer 122 and the application layer 124 in the OSI model 110. Accordingly, a Bluetooth profile may generally be considered synonymous with an “application” in the OSI seven-layer model 110. In relation to the Bluetooth HFP, the RFCOMM channel 142 comprises a communication channel named “service level connection” (“SLC”) (not shown) that emulates a serial port used for further communication between an Audio Gateway (AG) device and a Handsfree (HF) device. For voice audio connections, such as in the Bluetooth HFP, a separate baseband link called an SCO channel carries the voice data, represented as SCO audio 150 in FIG. 1. For A2DP, the audio data (unidirectional high-quality audio content, which may be in mono or stereo) goes over AVDTP 148, which in turn goes over L2CAP 140. At the radio level, all L2CAP 140 data flows over a logical link, as will be described in further detail below with reference to FIG. 4.

Bluetooth wireless technology systems generally come in two forms, which include Basic Rate (BR) and Low Energy (LE), wherein the former further includes optional Enhanced Data Rate (EDR) Alternate MAC and Physical (PHY) layer extensions. Bluetooth BR systems and BLE systems (e.g., Generic Audio Framework systems) both include device discovery, connection establishment, and connection mechanisms. The BLE system includes features designed to enable products that require lower current consumption, lower complexity, and lower cost than BR/EDR and has a design to support use cases and applications with lower data rates and lower duty cycles. The Bluetooth core system generally comprises a host and one or more controllers, wherein a host is a logical entity defined as all of the layers below the applications layer 156 in which the Bluetooth profiles are implemented and above the HCI 138, while a controller is a logical entity defined as all of the layers below the HCI 138. According to various aspects, a Bluetooth enabled device generally has one primary controller, which may be a BR/EDR controller that includes the RF layer 132, the baseband layer 134, the link manager protocol layer 136, and optionally the HCI 138. Alternatively, the primary controller may be an LE controller that includes the LE PHY, link manager protocol layer 136, and optionally the HCI 138. In a further alternative, the primary controller may combine a BR/EDR portion and a LE controller portion into a single controller, in which case the controller configuration has only one Bluetooth device address shared among the combined BR/EDR and LE controller portions.

As indicated above, FIG. 1 is provided as an example. Other examples may differ from what is described with regard to FIG. 1.

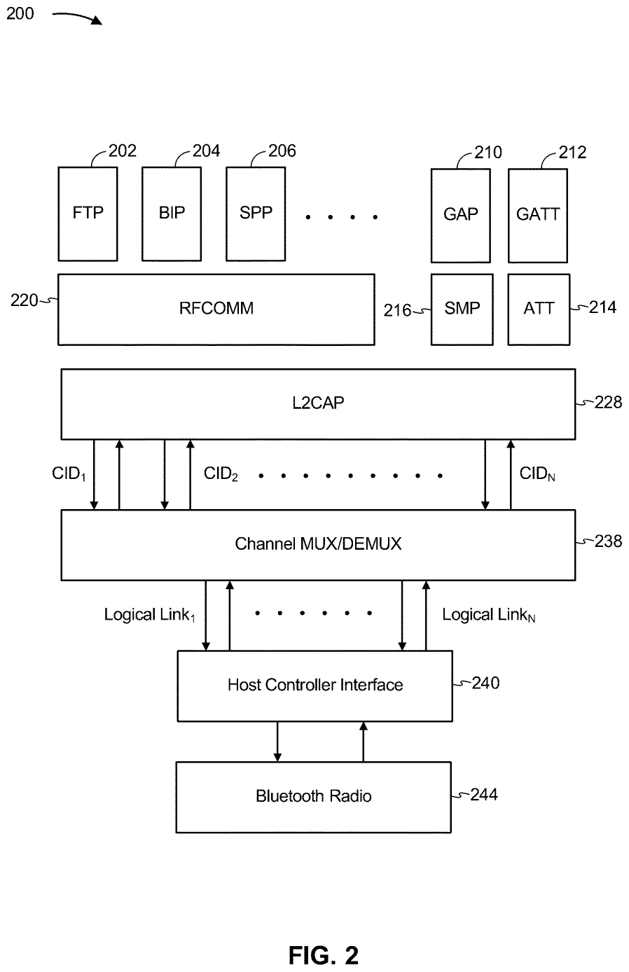

FIG. 2 is a diagram illustrating an example 200 of an implementation using the Bluetooth protocol stack to support one or more logical connections, in accordance with the present disclosure.

For example, the File Transfer Protocol (FTP) 202 provides a method to transfer files without the loss of data, which can include all file types including binary and American standard code for information interchange (ASCII) text, the Basic Imaging Profile (BIP) 204 establishes the fundamental requirements to enable negotiation of the size and encoding of image-related data, the Serial Port Profile (SPP) 206 defines how to set up virtual serial ports and connect two Bluetooth-enabled devices, and the RFCOMM 220 is a protocol based upon the standard for serial port emulation which has been adopted for Bluetooth. Furthermore, as mentioned above, the Bluetooth protocol stack shown at example 200 includes an L2CAP layer 228, which provides multiplexing (MUX) and demultiplexing (DEMUX) capabilities in the Bluetooth protocol stack. For example, the L2CAP layer 228 may establish a Channel ID (CID) link to a MUX/DEMUX sublayer 238, wherein a CID refers to a logical connection on the L2CAP layer 228 between two devices serving a single application or higher layer protocol. The MUX/DEMUX sublayer 238 may operate over a logical link that the baseband layer protocols provide. The HCI 240, upon receipt of data over a logical link, communicates the lower layer protocols to the host device (e.g., a Bluetooth-enabled laptop or mobile phone). The HCI 240 therefore represents the command interface to the baseband controller and provides uniform access to the baseband capabilities controlling the Bluetooth radio 244.

In Bluetooth BR/EDR and BLE implementations, the Bluetooth radio 244 operates in the unlicensed 2.4 GHz ISM band. In BLE implementations, a frequency hopping transceiver is employed to combat interference and fading and provides many Frequency Hopping Spread Spectrum (FHSS) carriers. In BLE, frequency division multiple access (FDMA) and/or time division multiple access (TDMA) schemes may be employed and the physical channel is sub-divided into time units (or “events”) in which packets may be positioned to transmit data between BLE devices. In general, there are two event types, which include advertising and connection events. Devices that transmit the advertising packets on the advertising PHY channels are referred to as advertisers and devices that receive advertising on the advertising channels without the intention to connect to the advertising device are referred to as scanners.

Transmissions on the advertising PHY channels occur in advertising events, wherein at the start of each advertising event, the advertiser sends an advertising packet corresponding to the advertising event type. Depending on the advertising packet type, the scanner may make a request to the advertiser on the same advertising PHY channel and a response from the advertiser on the same advertising PHY channel may follow the request. Above the physical channel, links, channels, and associated control protocols are arranged in a hierarchy based on a physical channel, a physical link, a logical transport, a logical link, and an L2CAP channel, as will be described in further detail below with respect to FIG. 4.

In Bluetooth BR/EDR and BLE implementations, the L2CAP layer 228 provides a channel-based abstraction to applications and services, wherein the L2CAP layer 228 fragments and de-fragments application data and multiplexes/de-multiplexes multiple channels over a shared logical link. In a BLE implementation, two additional protocol layers that reside above the L2CAP layer 228 are provided. In particular, the Security Manager protocol (SMP) 216 uses a fixed L2CAP channel to implement security functions between devices and the Attribute protocol (ATT) 214 provides a method to communicate small amounts of data over a fixed L2CAP channel. Devices also use the ATT protocol 214 to determine the services and capabilities associated with other devices. The ATT protocol 214 further depends on the Generic Access Profile (GAP) 210, which provides the basis for all other profiles and defines how two Bluetooth-enabled devices discover and establish a connection with each other. The Generic Attribute (GATT) Profile 212 is built on the ATT protocol 214 and defines a service framework to use the ATT protocol 214 according to procedures, formats, and characteristics associated with certain services (e.g., discovering, reading, writing, notifying, and indicating characteristics, configuring broadcast characteristics, etc.). In general, the GAP 210, the GATT profile 212, and the ATT protocol 214 are not transport-specific and can be used in Bluetooth BR/EDR and BLE implementations. However, BLE implementations are required to implement the GATT profile 212 and the ATT protocol 214 because the GATT profile 212 is used to discover services in Bluetooth LE.

As indicated above, FIG. 2 is provided as an example. Other examples may differ from what is described with regard to FIG. 2.

Bluetooth technology may support isochronous (time-bounded) data, which may refer to information in a stream where each information entity is bound to previous and successive entries according to a time relationship. In general, isochronous data may be used in many applications, including audio as well as time-limited data conveyed in a mesh network (e.g., a television broadcasting audio to one or more users, a music player transmitting personal audio, a public announcement system broadcasting audio within an airport, etc.).

Isochronous physical channels may enable isochronous data to be transferred via a connection-oriented configuration (e.g., a one-to-one configuration in which a source device transfers isochronous data to one sink device) or according to a connectionless configuration (e.g., a one-to-many configuration in which the source device broadcasts the isochronous data to one or more sink devices). In order to receive the isochronous data broadcasted via one or more channels, a sink device first receives synchronization information broadcasted via one or more advertising and/or synchronization packets and then synchronizes to the frequency hopping sub-events in the one or more channels.

Broadcast isochronous channels can be set up to enable a single source device to transmit data to a plurality of sink devices. For example, a UE may set up a broadcast isochronous channel to transmit streaming audio to a plurality of sets of earbuds, thereby enabling a plurality of users to listen to the streaming audio, rather than a single set of earbuds for a single user, as occurs with a unicast isochronous channel. A first sink device, which can receive a broadcast signal and which maintains a unicast control connection with the source device (e.g., for adjusting volume, pausing playback) may be referred to as a “primary sink device.” One or more second sink devices, which can receive the broadcast signal, but which do not maintain a unicast control connection with the source device, may be referred to as one or more “secondary sink devices.”

In unicast isochronous channels, the source device and the sink device may communicate on a control interface to enable transmit control. However, broadcast isochronous channels may lack a control interface, which may prevent a source device from performing a power control procedure. In this case, the source device may use a static value for a broadcast power level, which may be configured using a power parameter (Advertising_TX_Power) by a manufacturer of the source device. The transmit power level affects a range at which the source device can successfully transmit to a set of sink devices and/or a power consumption (e.g., by the source device to transmit a signal and/or by a sink device to receive and process the signal). Other power parameters may also be statically configured, such as a modulation and coding scheme or a quantity of repetitions of data that are provided to enable redundancy for lost packets. When the set of sink devices are relatively close to the source device, a static transmit configuration (e.g., a static transmit power) may result in excessive power consumption. Alternatively, when the set of sink devices are relatively far from the source device, the static transmit configuration may result in insufficient range for a successful transmission.

Some aspects described herein enable dynamic broadcast power control. For example, a source device may receive information identifying a link characteristic for a broadcast link with a set of secondary sink devices or a unicast link with a primary sink device. As one example, the source device may receive information identifying a link margin, such as a received signal strength indicator (RSSI), a signal-to-noise ratio (SNR), a packet error rate, or a block error rate (BLER), among other examples. As another example, the source device may receive information identifying a range (e.g., of the primary sink device or the set of secondary sink devices). Based at least in part on receiving information identifying the link characteristic, the source device may select a transmit configuration for transmitting a broadcast signal. For example, the source device may select a transmit power level, a modulation and coding scheme, a redundancy version, or another parameter. Additionally, or alternatively, when the link characteristic changes, the source device may dynamically update the transmit configuration. Additionally, or alternatively, the source device may receive information from the primary sink device explicitly setting the transmit configuration, such as a user selection of a transmit range for the broadcast signal.

Based at least in part on allowing for dynamic setting of a transmit configuration, the source device and/or one or more sink devices (e.g., a UE and/or one or more sets of earbuds, respectively) may conserve power resources and/or processing, network, and/or communication resources that may have otherwise been consumed transmitting a signal with excess power or processing a signal with insufficient power. For example, based at least in part on setting a transmit power to a high level when a sink device is far away or interference is high, the source device may transmit to the sink device with reduced error rate, which may conserve computing resources to detect and/or correct for communication errors. Moreover, this may reduce a likelihood of poor playback fidelity. Similarly, based at least in part on setting a transmit power to a low level when a sink device is close or interference is low, the source device may transmit to the sink device with reduced power, which may conserver power resources and extend battery life without negatively impacting playback fidelity.

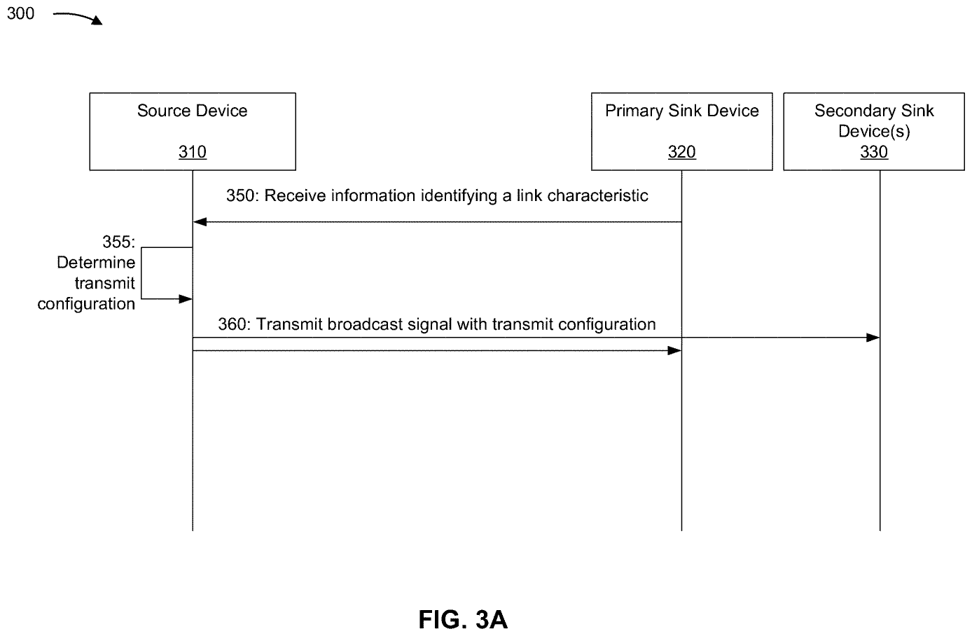

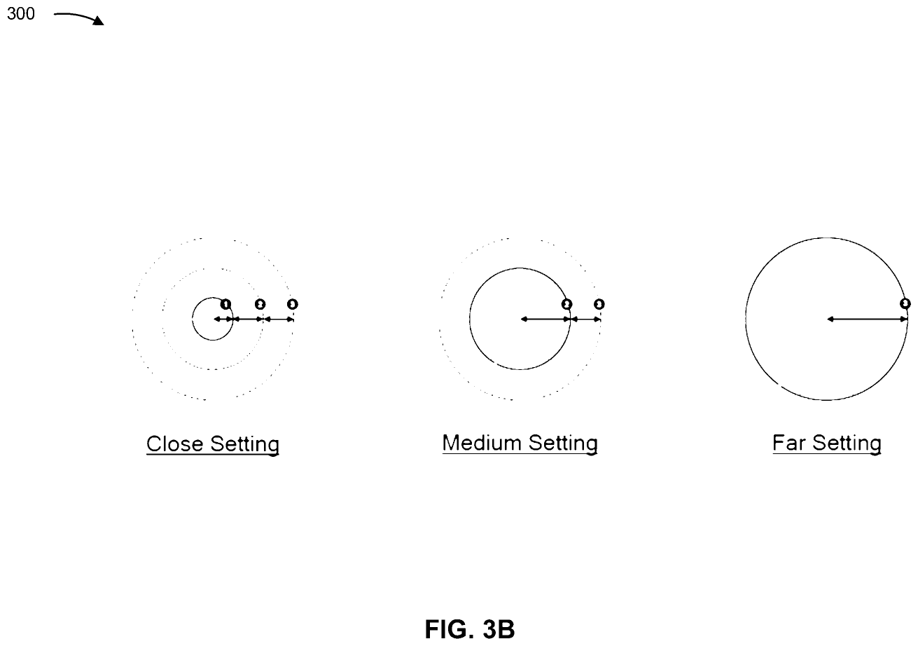

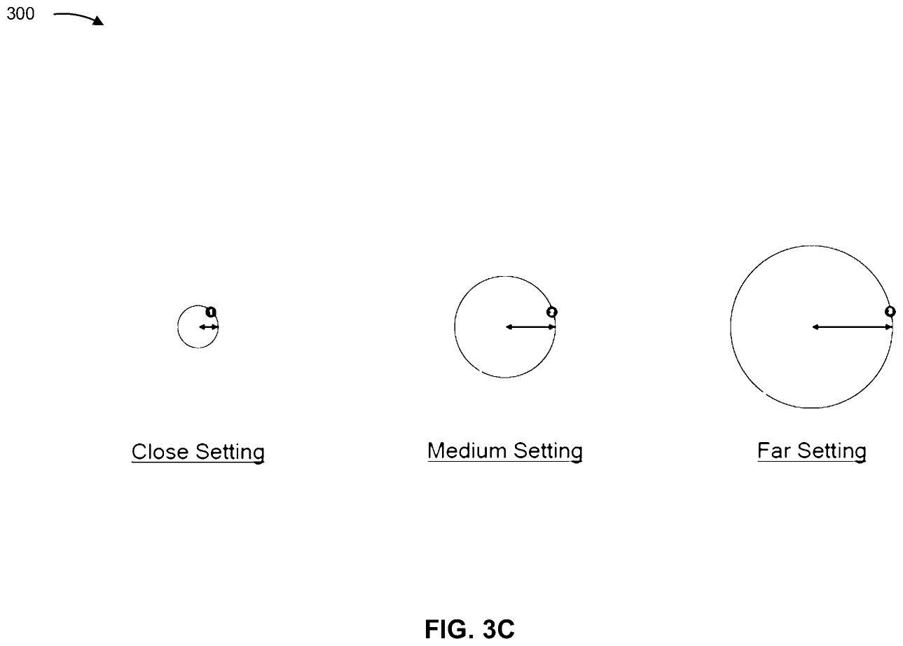

FIGS. 3A-3C are diagrams of an example 300 associated with dynamic broadcast power control, in accordance with the present disclosure. As shown in FIG. 3A, a source device 310 (e.g., a UE) may communicate with a primary sink device 320 (e.g., a first set of earbuds) and/or a set of secondary sink devices 330 (e.g., a set of second sets of earbuds).

As further shown in FIG. 3A, and by reference number 350, the source device 310 may receive information identifying a link characteristic. For example, the source device 310 may receive information from the primary sink device 320 (e.g., via a control connection, such as a unicast connection) indicating a link margin. In this case, the sink device 320 may determine, based at least in part on receiving a reference signal or other signal from the source device 310, the link margin, and may transmit reporting of the link margin to the source device 310. Additionally, or alternatively, the sink device 320 may transmit a reference signal or other signal to the source device 310, and the source device 310 may determine the link margin. The link margin may include one or more parameters associated with a link (e.g., a unicast link between the source device 310 and the primary sink device 320 or a broadcast link between the source device 310 and sink devices 320/330). For example, the link margin may be based at least in part on an RSSI, a reference signal received power (RSRP), an SNR, a packet error rate, a BLER, or another metric.

Additionally, or alternatively, when receiving information identifying a link characteristic, the source device 310 may receive information identifying a range value. For example, the primary sink device 320 may receive a signal from the source device 310 and determine a distance between the source device 310 and the primary sink device 320. In this case, the primary sink device 320 may report the determined distance to the source device 310. Additionally, or alternatively, the primary sink device 320 may transmit a signal to the source device 310, and the source device 310 may derive a distance to the primary sink device 320.

Additionally, or alternatively, the primary sink device 320 may provide a user interaction element (e.g., a button) with which to capture a user selection of a power setting or range value, and may transmit an indication of a user selected power setting or range value to the source device 310. Additionally, or alternatively, the source device 310 may provide a user interface element (e.g., a button on a screen) with which to capture a user selection of a power setting or a range value.

As further shown in FIG. 3A, and by reference numbers 355 and 360, the source device 310 may determine a transmit configuration and transmit a broadcast signal with the transmit configuration. For example, the source device 310 may determine a power level with which to transmit the broadcast signal (e.g., a Bluetooth signal) based at least in part on the link characteristic. Additionally, or alternatively, the source device 310 may determine another parameter for the transmit configuration, such as a modulation type or a quantity of repetitions to transmit (e.g., to enable lost data recovery at a sink device 320/330), among other examples. In this case, the broadcast signal may be transmitted to the primary sink device 320 and the set of secondary sink devices 330. The set of secondary sink devices 330 may be, in some aspects, passive receivers of the broadcast signal. Accordingly, in some aspects, the source device 310 may transmit the broadcast signal to the primary sink device 320 and a set of zero (or more) secondary sink devices 330.

Although some aspects are described in terms of Bluetooth audio, other types of broadcast signals, such as non-Bluetooth signals or Bluetooth video signals, are contemplated. Further, although some aspects are described in terms of broadcast signals, other types of signals, such as wideband signals, are contemplated.

In some aspects, the source device 310 may dynamically set the transmit configuration based at least in part on the link characteristic. For example, the source device 310 may identify a transmit power (or another transmit parameter) based at least in part on an RSSI of a connection with the primary sink device 320, and may transmit the broadcast signal with the transmit power for reception (e.g., by the primary sink device 320 and/or a set of secondary sink devices 330). In some aspects, the source device 310 may determine the transmit configuration based at least in part on a default parameter. For example, the source device 310 may be configured or be set (e.g., by a base station) with a default transmit power for broadcast transmissions, and may adjust the default transmit power (e.g., increase by an offset value or decrease by an offset value) based at least in part on the link characteristic. In some aspects, the source device 310 may transmit a first portion of a broadcast transmission using the default transmit power and may offset the default transmit power (e.g., to a lower or higher transmit power) for transmission of a second portion of the broadcast transmission. For example, the primary sink device 320 may receive, via a broadcast link, a first portion of the broadcast transmission transmitted using a default, static transmit power and determine a signal strength. The primary sink device 320 may report the signal strength to the source device 310, which may dynamically alter the default, static transmit power to a new, dynamic transmit power for transmitting a second portion of the broadcast transmission. In this case, the primary sink device 320 and the source device 310 may achieve transmit power control using an iterative process.

In some aspects, the source device 310 may dynamically set the transmit configuration based at least in part on a component link characteristic. For example, when the primary sink device 320 includes a plurality of components (e.g., a left earbud component and a right earbud component), each component may be associated with a separate link characteristic. In this case, when the source device 310 receives a report of a first link characteristic associated with a first component (e.g., a left earbud) and a second link characteristic associated with a second component (e.g., a right earbud) the source device 310 may determine the transmit configuration based at least in part on the first link characteristic and/or the second link characteristic. In this case, the source device 310 may combine a plurality of link characteristics (e.g., by averaging) or may select a link characteristic from the plurality of link characteristics (e.g., select a worse link characteristic, such as a link characteristic indicating a greater distance or worse RSSI) to determine the transmit configuration.

In some aspects, the source device 310 may set the transmit configuration based at least in part on an application characteristic. For example, when the source device 310 is transmitting streaming audio in connection with a streaming video that is being provided for display by the source device 310, the source device 310 may select a lower transmit power. In this case, users of sink devices 320/330 may be considered likely to crowd around the source device 310 to view the streaming video. Alternatively, when the source device 310 is transmitting streaming audio without streaming video (or with streaming video that is being cast to a larger display), the source device 310 may select a higher transmit power. In this case, users of sink devices 320/330 may be considered less likely to crowd around the source device 310 as there is no video to view (or the video is being displayed via another display at another location). Additionally, or alternatively, when the source device 310 is transmitting streaming audio to a set of Bluetooth speaker sink devices 320, the source device 310 may select a higher transmit power level than when the source device 310 is transmitting streaming audio to a set of earbuds, as the speakers may be more likely to be positioned in separate rooms to play the same audio than individual earbud users attempting to listen to the same audio. In some aspects, when the source device 310 has a battery level less than a threshold value, the source device 310 may select a lower transmit power to conserve power resources. Additionally, or alternatively, when the source device 310 determines (e.g., based at least in part on received control signaling) that the primary sink device 320 has a battery level less than a threshold value, the source device 310 may select a higher transmit power to reduce processing by the primary sink device 320 (e.g., to recover dropped portions of the broadcast transmission), thereby conserving power resources at the primary sink device 320. Other types of application characteristics, device characteristics, or use case characteristics for which transmit configurations can be set are contemplated.

In some aspects, the source device 310 may dynamically set the transmit configuration using a set of threshold minimum transmit powers. For example, as shown in FIG. 3B, the source device 310 may be configured with a first transmit configuration (“Close Setting”), a second transmit configuration (“Medium Setting”), and a third transmit configuration (“Far Setting”). In this case, each transmit configuration may be associated with one or more regions. For example, the first transmit configuration is associated with regions 1-3, the second transmit configuration is associated with regions 2-3, and the third transmit configuration is associated with region 3. The source device 310 may use the transmit configuration as a minimum transmit power (or a minimum quantity of repetitions, or a minimum type of modulation order) and may adapt an actual transmit power based at least in part on a ranging determination of the primary sink device 320. As a result, in the first transmit configuration, when the primary sink device 320 is detected in region 1, a first transmit power is used; when the primary sink device 320 is detected in region 2, a second transmit power is used; and when the primary sink device 320 is detected in region 3, a third transmit power is used. In contrast, in the second transmit configuration, the second transmit power is a minimum transmit power used in region 2 and the third transmit power is an increased transmit power used in region 3. In other words, in the first transmit configuration, the first transmit power is a minimum transmit power and the second and third transmit powers are optionally used; in contrast, in the second transmit configuration, the first transmit power is not used, the second transmit power is a minimum transmit power, and the third transmit power is optionally used. Similarly, in the third transmit configuration, the third transmit power is a minimum transmit power. This enables the source device 310 to set a minimum range at which all sink devices 320/330 can receive the broadcast signal, but the source device 310 can increase the range when the primary sink device 320 is determined to be at a greater range from the source device 310.

In some aspects, the source device 310 may receive a selection from a plurality of transmit configurations. For example, the source device 310 may detect a user disabling an automatic transmit configuration determination mode and may detect a manual user selection of a transmit configuration. As shown in FIG. 3C, the source device 310 may be configured with a first transmit configuration (“Close Setting”), a second transmit configuration (“Medium Setting”), and a third transmit configuration (“Far Setting”). In this case, when the source device 310 provides a user interface element with which a user can select a transmit configuration, the user can select from the plurality of transmit configurations to account for an expected distance of sink devices 320/330 to the source device 310. In this case, when the source device 310 receives a selection of the close setting, transmit power is set to a low level. In contrast, when the source device 310 receives a selection of the far setting, the transmit power is set to a high level. In some aspects, the source device 310 can switch between transmit configurations during a broadcast transmission. For example, after a start of the broadcast transmission, the source device 310 can receive a change to a selection (e.g., from the close setting to the medium setting) and may change a transmit power of the broadcast transmission based on the change to the selection. In this way, the source device 310 can allow user selection and dynamic changing of the transmit power (or another transmit parameter) even when, for example, ranging is not configured.

As indicated above, FIGS. 3A-3C are provided as an example. Other examples may differ from what is described with respect to FIGS. 3A-3C.

FIG. 4 is a diagram illustrating an example process 400 performed, for example, by a source device, in accordance with the present disclosure. Example process 400 is an example where the source device (e.g., source device 310 or the wireless communication device 800) performs operations associated with dynamic broadcast power control.

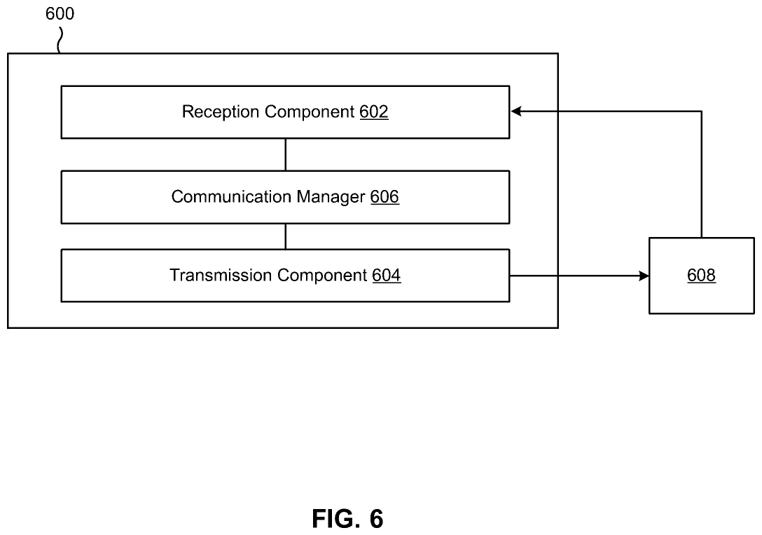

As shown in FIG. 4, in some aspects, process 400 may include receiving information associated with identifying a link characteristic for a first communication link between the source device and a primary sink device or for a second communication link between the source device and a set of secondary sink devices (block 410). For example, the source device (e.g., using reception component 602 and/or communication manager 606, depicted in FIG. 6) may receive information associated with identifying a link characteristic for a first communication link between the source device and a primary sink device or for a second communication link between the source device and a set of secondary sink devices, as described above.

As further shown in FIG. 4, in some aspects, process 400 may include transmitting, using a transmit configuration associated with the link characteristic, a broadcast signal to the primary sink device and the set of secondary sink devices (block 420). For example, the source device (e.g., using transmission component 604 and/or communication manager 606, depicted in FIG. 6) may transmit, using a transmit configuration associated with the link characteristic, a broadcast signal to the primary sink device and the set of secondary sink devices, as described above.

Process 400 may include additional aspects, such as any single aspect or any combination of aspects described below and/or in connection with one or more other processes described elsewhere herein.

In a first aspect, the link characteristic includes at least one of a link margin metric, a received signal strength indicator, a signal-to-noise ratio, a packet error rate, or a ranging determination.

In a second aspect, alone or in combination with the first aspect, the transmit configuration includes at least one of a transmit power, a modulation type, or a repetition factor.

In a third aspect, alone or in combination with one or more of the first and second aspects, the transmit configuration is a second transmit configuration, and transmitting the broadcast signal comprises transmitting a first portion of the broadcast signal using a first transmit configuration that is based at least in part on a static parameter, and transmitting a second portion of the broadcast signal using the second transmit configuration, the second transmit configuration being different from the first transmit configuration.

In a fourth aspect, alone or in combination with one or more of the first through third aspects, process 400 includes disabling a dynamic power control functionality, detecting a selection of a new transmit configuration, and switching from transmitting the broadcast signal using the transmit configuration to transmitting the broadcast signal using the new transmit configuration.

In a fifth aspect, alone or in combination with one or more of the first through fourth aspects, the transmit configuration is based at least in part on an application characteristic associated with a content of the broadcast signal.

In a sixth aspect, alone or in combination with one or more of the first through fifth aspects, the broadcast signal is a Bluetooth broadcast signal.

In a seventh aspect, alone or in combination with one or more of the first through sixth aspects, the primary sink device includes a first component and a second component, the first component being associated with a first link characteristic, and the second component being associated with a second link characteristic.

In an eighth aspect, alone or in combination with one or more of the first through seventh aspects, the transmit configuration is associated with at least one of the first link characteristic of the second link characteristic.

In a ninth aspect, alone or in combination with one or more of the first through eighth aspects, the transmit configuration is based at least in part on a minimum transmit metric.

In a tenth aspect, alone or in combination with one or more of the first through ninth aspects, the transmit configuration is based at least in part on a battery power level.

In an eleventh aspect, alone or in combination with one or more of the first through tenth aspects, the transmit configuration is based at least in part on an expected range.

In a twelfth aspect, alone or in combination with one or more of the first through eleventh aspects, the transmit configuration is selected from a plurality of configured transmit configurations.

In a thirteenth aspect, alone or in combination with one or more of the first through twelfth aspects, process 400 includes detecting a change to the link characteristic for the first communication link or the second communication link, and transmitting the broadcast signal using an updated transmit configuration that is based at least in part on the change to the link characteristic for the first communication link or the second communication link.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

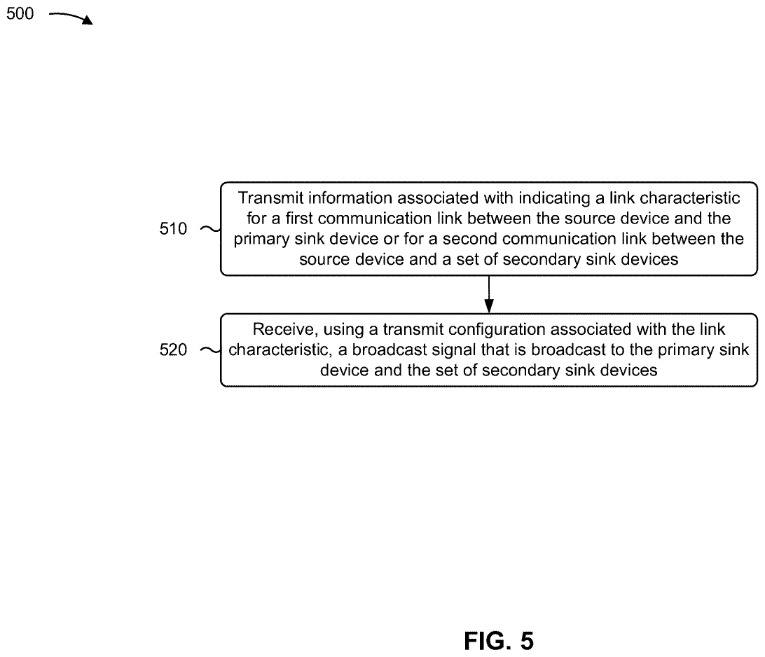

FIG. 5 is a diagram illustrating an example process 500 performed, for example, by a primary sink device, in accordance with the present disclosure. Example process 500 is an example where the primary sink device (e.g., primary sink device 320) performs operations associated with dynamic broadcast power control.

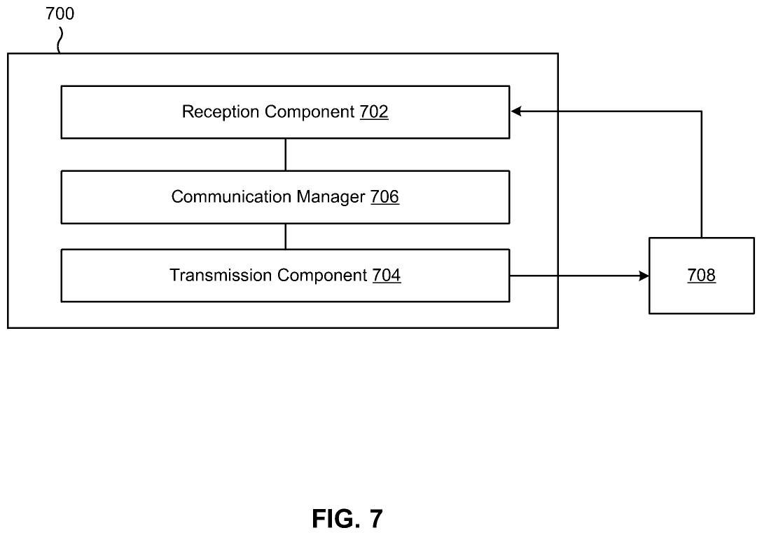

As shown in FIG. 5, in some aspects, process 500 may include transmitting information associated with indicating a link characteristic for a first communication link between the source device and the primary sink device or for a second communication link between the source device and a set of secondary sink devices (block 510). For example, the primary sink device (e.g., using transmission component 704 and/or communication manager 706, depicted in FIG. 7) may transmit information associated with indicating a link characteristic for a first communication link between the source device and the primary sink device or for a second communication link between the source device and a set of secondary sink devices, as described above.

As further shown in FIG. 5, in some aspects, process 500 may include receiving, using a transmit configuration associated with the link characteristic, a broadcast signal that is broadcast to the primary sink device and the set of secondary sink devices (block 520). For example, the primary sink device (e.g., using reception component 702 and/or communication manager 706, depicted in FIG. 7) may receive, using a transmit configuration associated with the link characteristic, a broadcast signal that is broadcast to the primary sink device and the set of secondary sink devices, as described above.

Process 500 may include additional aspects, such as any single aspect or any combination of aspects described below and/or in connection with one or more other processes described elsewhere herein.

In a first aspect, the link characteristic includes at least one of a link margin metric, a received signal strength indicator, a signal-to-noise ratio, a packet error rate, or a ranging determination.

In a second aspect, alone or in combination with the first aspect, the transmit configuration includes at least one of a transmit power, a modulation type, or a repetition factor.

In a third aspect, alone or in combination with one or more of the first and second aspects, the transmit configuration is a second transmit configuration, and receiving the broadcast signal comprises receiving a first portion of the broadcast signal using a first transmit configuration that is based at least in part on a static parameter, and receiving a second portion of the broadcast signal using the second transmit configuration, the second transmit configuration being different from the first transmit configuration.

In a fourth aspect, alone or in combination with one or more of the first through third aspects, process 500 includes disabling a dynamic power control functionality, detecting a selection of a new transmit configuration, transmitting an indication of the new transmit configuration to the source device, and receiving the broadcast signal using the new transmit configuration.

In a fifth aspect, alone or in combination with one or more of the first through fourth aspects, the transmit configuration is based at least in part on an application characteristic associated with a content of the broadcast signal.

In a sixth aspect, alone or in combination with one or more of the first through fifth aspects, the broadcast signal is a Bluetooth broadcast signal.

In a seventh aspect, alone or in combination with one or more of the first through sixth aspects, the primary sink device includes a first component and a second component, the first component being associated with a first link characteristic, and the second component being associated with a second link characteristic.

In an eighth aspect, alone or in combination with one or more of the first through seventh aspects, the transmit configuration is associated with at least one of the first link characteristic of the second link characteristic.

In a ninth aspect, alone or in combination with one or more of the first through eighth aspects, the transmit configuration is based at least in part on a minimum transmit metric.

In a tenth aspect, alone or in combination with one or more of the first through ninth aspects, the transmit configuration is based at least in part on a battery power level.

In an eleventh aspect, alone or in combination with one or more of the first through tenth aspects, the transmit configuration is based at least in part on an expected range.

In a twelfth aspect, alone or in combination with one or more of the first through eleventh aspects, the transmit configuration is selected from a plurality of configured transmit configurations.

In a thirteenth aspect, alone or in combination with one or more of the first through twelfth aspects, process 500 includes transmitting information indicating a change to the link characteristic for the first communication link or the second communication link, and receiving the broadcast signal using an updated transmit configuration that is based at least in part on the change to the link characteristic for the first communication link or the second communication link.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

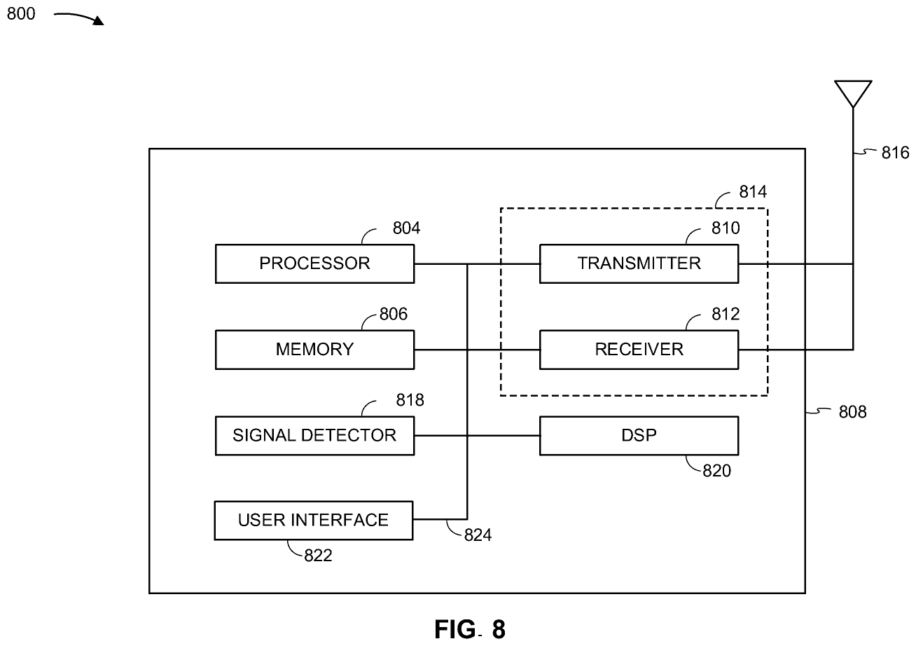

FIG. 6 is a diagram of an example apparatus 600 for wireless communication, in accordance with the present disclosure. The apparatus 600 may be a source device (e.g., a UE), or a source device may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager described in connection with FIG. 8. As shown, the apparatus 600 may communicate with another apparatus 608, such as a sink device, using the reception component 602 and the transmission component 604.

In some aspects, the apparatus 600 may be configured to perform one or more operations described herein in connection with FIGS. 3A-3C. Additionally, or alternatively, the apparatus 600 may be configured to perform one or more processes described herein, such as process 400 of FIG. 4. In some aspects, the apparatus 600 and/or one or more components shown in FIG. 6 may include one or more components of the source device described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a multiple input, multiple output (MIMO) detector, a receive processor, a controller/processor, a memory, or a combination thereof, of the source device described in connection with FIG. 2.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 608. In some aspects, the transmission component 604 may include one or more antennas, a modem, a modulator, a transmit MIMO processor, a transmit processor, a controller/processor, a memory, or a combination thereof, of the source device described in connection with FIG. 2. In some aspects, the transmission component 604 may be co-located with the reception component 602 in a transceiver.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The reception component 602 may receive information associated with identifying a link characteristic for a first communication link between the source device and a primary sink device or for a second communication link between the source device and a set of secondary sink devices. The transmission component 604 may transmit, using a transmit configuration associated with the link characteristic, a broadcast signal to the primary sink device and the set of secondary sink devices.

The communication manager 606 may disable a dynamic power control functionality. The communication manager 606 may detect a selection of a new transmit configuration. The communication manager 606 may switch from transmitting the broadcast signal using the transmit configuration to transmitting the broadcast signal using the new transmit configuration. The communication manager 606 may detect a change to the link characteristic for the first communication link or the second communication link. The transmission component 604 may transmit the broadcast signal using an updated transmit configuration that is based at least in part on the change to the link characteristic for the first communication link or the second communication link.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a sink device (e.g., a pair of Bluetooth earbuds or a Bluetooth speaker), or a sink device may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager described in connection with FIG. 8. As shown, the apparatus 700 may communicate with another apparatus 708, such as a source device, using the reception component 702 and the transmission component 704.

In some aspects, the apparatus 700 may be configured to perform one or more operations described herein in connection with FIGS. 3A-3C. Additionally, or alternatively, the apparatus 700 may be configured to perform one or more processes described herein, such as process 500 of FIG. 5. In some aspects, the apparatus 700 and/or one or more components shown in FIG. 7 may include one or more components of the sink device described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the sink device described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the sink device described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit information associated with indicating a link characteristic for a first communication link between the source device and the primary sink device or for a second communication link between the source device and a set of secondary sink devices. The reception component 702 may receive, using a transmit configuration associated with the link characteristic, a broadcast signal that is broadcast to the primary sink device and the set of secondary sink devices.

The communication manager 706 may disable a dynamic power control functionality. The communication manager 706 may detect a selection of a new transmit configuration. The transmission component 704 may transmit an indication of the new transmit configuration to the source device. The reception component 702 may receive the broadcast signal using the new transmit configuration. The transmission component 704 may transmit information indicating a change to the link characteristic for the first communication link or the second communication link. The reception component 702 may receive the broadcast signal using an updated transmit configuration that is based at least in part on the change to the link characteristic for the first communication link or the second communication link.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components.

Additionally, or alternatively, a set of (one or more) components shown in FIG. 7 may perform one or more functions described as being performed by another set of components shown in FIG. 7.

FIG. 8 is a diagram illustrating an example of a wireless communication device 800, according to aspects of the disclosure.

The wireless communication device 800 shown in FIG. 8 may correspond to, include, or be included in a source device 310 or a sink device 320/330. In some aspects, the wireless communication device 800 may include one or more processors 804, one or more memories 806, a housing 808, a transmitter 810, a receiver 812, an antenna 816, a signal detector 818, a digital signal processor (DSP) 820, a user interface 822, and a bus 824. Alternatively, the functions associated with the transmitter 810 and the receiver 812 can be incorporated into a transceiver 814. The wireless communication device 800 can be configured to communicate in a wireless network that includes, for example, a base station, an access point, and the like.

In some aspects, a processor 804 can be configured to control operations associated with the wireless communication device, wherein the processor 804 may also be referred to as a central processing unit (CPU). A memory 806 can be coupled to the processor 804, can be in communication with the processor 804, and can provide instructions and data to the processor 804. The processor 804 can perform logical and arithmetic operations based on program instructions stored within the memory 806. The instructions in the memory 806 can be executable to perform one or more methods and processes described herein. Furthermore, in some aspects, the processor 804 can include, or be a component in, a processing system implemented with one or more processors. The one or more processors can be implemented with any one or more general-purpose microprocessors, microcontrollers, DSPs, field programmable gate array (FPGAs), programmable logic devices (PLDs), controllers, state machines, gated logic, discrete hardware components, dedicated hardware finite state machines, combinations thereof, and/or any other suitable entities that can perform calculations and/or manipulate information. In some aspects, the processing system can also include machine-readable media configured to store software, which can be broadly construed to include any suitable instructions, whether referred to as software, firmware, middleware, microcode, hardware description language, or otherwise. Instructions can include code in a source code format, a binary code format, an executable code format, and/or any other suitable format. The instructions, when executed on the one or more processors, can cause the processing system to perform one or more of the functions described herein.

In some aspects, the memory 806 can include read-only memory (ROM), random access memory (RAM), and/or any suitable combination thereof. The memory 806 can also include non-volatile random access memory (NVRAM).

In some aspects, the transmitter 810 and the receiver 812 (or the transceiver 814) can transmit and receive data between the wireless communication device and a remote location.

The antenna 816 can be attached to the housing 808 and electrically coupled to the transceiver 814. In some implementations, the wireless communication device can also include multiple transmitters, multiple receivers, multiple transceivers, and/or multiple antennas (not illustrated). In some aspects, the signal detector 818 can be used to detect and quantify the level associated with one or more signals received at the transceiver 814. The signal detector 818 can detect such signals as total energy, energy per subcarrier per symbol, power spectral density, and/or and in other ways. In some aspects, the DSP 820 can be used to process signals, wherein the DSP 820 can be configured to generate a packet to be transmitted via the transmitter 810 and/or the transceiver 814. In some aspects, the packet can include a physical layer protocol data unit (PPDU).

In some aspects, the user interface 822 can include, for example, a keypad, a microphone, a speaker, a display, and/or other suitable interfaces. The user interface 822 can include any element or component that conveys information to a user associated with the wireless communication device and/or receives input from the user.

In some aspects, the various components associated with the wireless communication device can be coupled together via a bus 824, which may include a data bus and a power bus, a control signal bus, and/or a status signal bus in addition to the data bus.

In some aspects, the wireless communication device can also include other components or elements not illustrated in FIG. 8. One or more components associated with the wireless communication device can be in communication with another one or more components associated with the wireless communication device via means that may comprise another communication channel (not illustrated) to provide, for example, an input signal to the other component.

In some aspects, although various separate components are illustrated in FIG. 8, one or more components shown therein can be combined or commonly implemented. For example, the processor 804 and the memory 806 can be embodied on a single chip. The processor 804 can additionally, or in the alternative, contain memory, such as processor registers. Similarly, one or more functional blocks or portions thereof can be embodied on a single chip. Alternatively, the functionality associated with a particular block can be implemented on two or more chips. For example, the processor 804 can be used to implement not only the functionality described above with respect to the processor 804, but also to implement the functionality described above with respect to the signal detector 818 and/or the DSP 820. In some aspects, the wireless communication device 800 may be a source device or a sink device (e.g., a primary sink device or a secondary sink device).

In some aspects, the wireless communication device 800 includes means for receiving information associated with identifying a link characteristic for a first communication link between the wireless communication device 800 and a primary sink device or for a second communication link between the source device and a set of secondary sink devices; and/or means for transmitting, using a transmit configuration associated with the link characteristic, a broadcast signal to the primary sink device and the set of secondary sink devices. In some aspects, the wireless communication device 800 includes means for transmitting information associated with indicating a link characteristic for a first communication link between the source device and the wireless communication device 800 or for a second communication link between the source device and a set of secondary sink devices; and/or means for receiving, using a transmit configuration associated with the link characteristic, a broadcast signal that is broadcast to the wireless communication device 800 and the set of secondary sink devices. In some aspects, the means for the wireless communication device 800 to perform operations described herein may include, for example, one or more of processor 804, memory 806, transmitter 810, receiver 812, antenna 816 DSP 820, or bus 824.

In some aspects, the wireless communication device 800 may include a communication manager. The communication manager may receive information associated with identifying a link characteristic for a first communication link between a source device and a primary sink device or for a second communication link between the source device and a set of secondary sink devices; and transmit, using a transmit configuration associated with the link characteristic, a broadcast signal to the primary sink device and the set of secondary sink devices. The communication manager may transmit information associated with indicating a link characteristic for a first communication link between the source device and the primary sink device or for a second communication link between the source device and a set of secondary sink devices; and receive, using a transmit configuration associated with the link characteristic, a broadcast signal that is broadcast to the primary sink device and the set of secondary sink devices. Additionally, or alternatively, the communication manager may perform one or more other operations described herein.

As indicated above, FIG. 8 is provided as an example. Other examples may differ from what is described with regard to FIG. 8.

The following provides an overview of some Aspects of the present disclosure:

Aspect 1: A method of wireless communication performed by a source device, comprising: receiving information associated with identifying a link characteristic for a first communication link between the source device and a primary sink device or for a second communication link between the source device and a set of secondary sink devices; and transmitting, using a transmit configuration associated with the link characteristic, a broadcast signal to the primary sink device and the set of secondary sink devices.

Aspect 2: The method of Aspect 1, wherein the link characteristic includes at least one of: a link margin metric, a received signal strength indicator, a signal-to-noise ratio, a packet error rate, or a ranging determination.

Aspect 3: The method of any of Aspects 1-2, wherein the transmit configuration includes at least one of a transmit power, a modulation type, or a repetition factor.

Aspect 4: The method of any of Aspects 1-3, wherein the transmit configuration is a second transmit configuration, and further comprising: transmitting a first portion of the broadcast signal using a first transmit configuration that is based at least in part on a static parameter; and wherein transmitting the broadcast signal comprises: transmitting a second portion of the broadcast signal using the second transmit configuration, the second transmit configuration being different from the first transmit configuration.

Aspect 5: The method of any of Aspects 1-4, further comprising: disabling a dynamic power control functionality; detecting a selection of a new transmit configuration; and switching from transmitting the broadcast signal using the transmit configuration to transmitting the broadcast signal using the new transmit configuration.

Aspect 6: The method of any of Aspects 1-5, wherein the transmit configuration is based at least in part on an application characteristic associated with a content of the broadcast signal.

Aspect 7: The method of any of Aspects 1-6, wherein the broadcast signal is a Bluetooth broadcast signal.

Aspect 8: The method of any of Aspects 1-7, wherein the primary sink device includes a first component and a second component, the first component being associated with a first link characteristic, and the second component being associated with a second link characteristic.

Aspect 9: The method of Aspect 8, wherein the transmit configuration is associated with at least one of the first link characteristic of the second link characteristic.

Aspect 10: The method of any of Aspects 1-9, wherein the transmit configuration is based at least in part on a minimum transmit metric.

Aspect 11: The method of any of Aspects 1-10, wherein the transmit configuration is based at least in part on a battery power level.

Aspect 12: The method of any of Aspects 1-11, wherein the transmit configuration is based at least in part on an expected range.

Aspect 13: The method of any of Aspects 1-12, wherein the transmit configuration is selected from a plurality of configured transmit configurations.

Aspect 14: The method of any of Aspects 1-13, further comprising: detecting a change to the link characteristic for the first communication link or the second communication link; and transmitting the broadcast signal using an updated transmit configuration that is based at least in part on the change to the link characteristic for the first communication link or the second communication link.

Aspect 15: A method of wireless communication performed by a primary sink device, comprising: transmitting information associated with indicating a link characteristic for a first communication link between the source device and the primary sink device or for a second communication link between the source device and a set of secondary sink devices; and receiving, using a transmit configuration associated with the link characteristic, a broadcast signal that is broadcast to the primary sink device and the set of secondary sink devices.

Aspect 16: The method of Aspect 15, wherein the link characteristic includes at least one of: a link margin metric, a received signal strength indicator, a signal-to-noise ratio, a packet error rate, or a ranging determination.

Aspect 17: The method of any of Aspects 15-16, wherein the transmit configuration includes at least one of a transmit power, a modulation type, or a repetition factor.

Aspect 18: The method of any of Aspects 15-17, wherein the transmit configuration is a second transmit configuration, and further comprising: receiving a first portion of the broadcast signal using a first transmit configuration that is based at least in part on a static parameter; and wherein receiving the broadcast signal comprises: receiving a second portion of the broadcast signal using the second transmit configuration, the second transmit configuration being different from the first transmit configuration.

Aspect 19: The method of any of Aspects 15-18, further comprising: disabling a dynamic power control functionality; detecting a selection of a new transmit configuration; transmitting an indication of the new transmit configuration to the source device; and receiving the broadcast signal using the new transmit configuration.

Aspect 20: The method of any of Aspects 15-19, wherein the transmit configuration is based at least in part on an application characteristic associated with a content of the broadcast signal.

Aspect 21: The method of any of Aspects 15-20, wherein the broadcast signal is a Bluetooth broadcast signal.

Aspect 22: The method of any of Aspects 15-21, wherein the primary sink device includes a first component and a second component, the first component being associated with a first link characteristic, and the second component being associated with a second link characteristic.

Aspect 23: The method of Aspect 22, wherein the transmit configuration is associated with at least one of the first link characteristic of the second link characteristic.

Aspect 24: The method of any of Aspects 15-23, wherein the transmit configuration is based at least in part on a minimum transmit metric.

Aspect 25: The method of any of Aspects 15-24, wherein the transmit configuration is based at least in part on a battery power level.

Aspect 26: The method of any of Aspects 15-25, wherein the transmit configuration is based at least in part on an expected range.

Aspect 27: The method of any of Aspects 15-26, wherein the transmit configuration is selected from a plurality of configured transmit configurations.

Aspect 28: The method of any of Aspects 15-27, further comprising: transmitting information indicating a change to the link characteristic for the first communication link or the second communication link; and receiving the broadcast signal using an updated transmit configuration that is based at least in part on the change to the link characteristic for the first communication link or the second communication link.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include zero or more items and may be used interchangeably with “zero or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A source device for wireless communication, comprising:
one or more memories; and
one or more processors, coupled to the one or more memories, configured to:
receive information associated with identifying a link characteristic for a first communication link between the source device and a primary sink device or for a second communication link between the source device and a set of secondary sink devices; and
transmit, using a transmit configuration associated with the link characteristic, a broadcast signal to the primary sink device and the set of secondary sink devices.

2. The source device of claim 1, wherein the link characteristic includes at least one of:
a link margin metric,
a received signal strength indicator,
a signal-to-noise ratio,
a packet error rate, or
a ranging determination.

3. The source device of claim 1, wherein the transmit configuration includes at least one of a transmit power, a modulation type, or a repetition factor.

4. The source device of claim 1, wherein the transmit configuration is a second transmit configuration, and
further comprise:
transmit a first portion of the broadcast signal using a first transmit configuration that is based at least in part on a static parameter; and
wherein the one or more processors, to transmit the broadcast signal, are configured to:
transmit a second portion of the broadcast signal using the second transmit configuration, the second transmit configuration being different from the first transmit configuration.

5. The source device of claim 1, wherein the one or more processors are further configured to:
disable a dynamic power control functionality;
detect a selection of a new transmit configuration; and
switch from transmitting the broadcast signal using the transmit configuration to transmitting the broadcast signal using the new transmit configuration.

6. The source device of claim 1, wherein the transmit configuration is based at least in part on an application characteristic associated with a content of the broadcast signal.

7. The source device of claim 1, wherein the broadcast signal is a Bluetooth broadcast signal.

8. The source device of claim 1, wherein the primary sink device includes a first component and a second component, the first component being associated with a first link characteristic, and the second component being associated with a second link characteristic.

9. The source device of claim 8, wherein the transmit configuration is associated with at least one of the first link characteristic of the second link characteristic.

10. The source device of claim 1, wherein the transmit configuration is based at least in part on a minimum transmit metric.

11. The source device of claim 1, wherein the transmit configuration is based at least in part on a battery power level.

12. The source device of claim 1, wherein the transmit configuration is based at least in part on an expected range.

13. The source device of claim 1, wherein the transmit configuration is selected from a plurality of configured transmit configurations.

14. The source device of claim 1, wherein the one or more processors are further configured to:
detect a change to the link characteristic for the first communication link or the second communication link; and
transmit the broadcast signal using an updated transmit configuration that is based at least in part on the change to the link characteristic for the first communication link or the second communication link.

15. A primary sink device for wireless communication, comprising:
one or more memories; and
one or more processors, coupled to the one or more memories, configured to:
transmit information associated with indicating a link characteristic for a first communication link between a source device and the primary sink device or for a second communication link between the source device and a set of secondary sink devices; and
receive, using a transmit configuration associated with the link characteristic, a broadcast signal that is broadcast to the primary sink device and the set of secondary sink devices.

16. The primary sink device of claim 15, wherein the link characteristic includes at least one of:
a link margin metric,
a received signal strength indicator,
a signal-to-noise ratio,
a packet error rate, or
a ranging determination.

17. The primary sink device of claim 15, wherein the transmit configuration includes at least one of a transmit power, a modulation type, or a repetition factor.

18. The primary sink device of claim 15, wherein the transmit configuration is a second transmit configuration, and
further comprise:
receive a first portion of the broadcast signal using a first transmit configuration that is based at least in part on a static parameter; and
wherein the one or more processors, to receive the broadcast signal, are configured to:
receive a second portion of the broadcast signal using the second transmit configuration, the second transmit configuration being different from the first transmit configuration.

19. The primary sink device of claim 15, wherein the one or more processors are further configured to:
disable a dynamic power control functionality;
detect a selection of a new transmit configuration;
transmit an indication of the new transmit configuration to the source device; and
receive the broadcast signal using the new transmit configuration.

20.-28. (canceled)

29. A method of wireless communication performed by a source device, comprising:
receiving information associated with identifying a link characteristic for a first communication link between the source device and a primary sink device or for a second communication link between the source device and a set of secondary sink devices; and
transmitting, using a transmit configuration associated with the link characteristic, a broadcast signal to the primary sink device and the set of secondary sink devices.

30. (canceled)
